(19) United States
(12) Patent Application Publication
(10) Pub. No.: US 2011/0040784 A1
(43) Pub. Date: Feb. 17, 2011

(54) COMPUTER DEVICE FOR THE TIME-BASED MANAGEMENT OF DIGITAL DOCUMENTS

(76) Inventor: Guillaume Rousseau, Paris (FR)

Correspondence Address: CHRISTIE, PARKER & HALE, LLP, PO BOX 7068, PASADENA, CA, 91109-7068, US

(21) Appl. No.: 12/989,376

(22) PCT Filed: Apr. 21, 2009
(86) PCT No.: PCT/FR2009/000471

§ 371 Date: Oct. 22, 2010

(30) Foreign Application Priority Data
Apr. 25, 2008 (FR) 0802333

(51) Int. Cl. G06F 17/30

(52) U.S. Cl. 707/769; 707/E17.014

(57) ABSTRACT

Device for managing digital documents, comprising a memory (3) for storing a digital document and a date stamp including first signatures established according to a first method and a time value, a signature generator (5) for establishing second signatures according to a second method, a time stamper, a signature verifier (9) for verifying that a document and a date stamp match, and a supervisor (11) for effecting the operation of the signature generator (5) on the document, effecting the operation of the signature verifier (9) on the document and its date stamp, and, in the event of a match, effecting the operation of the time stamper (7) on the second signatures with the time value.

The invention relates to a device for the time-based management of digital documents.

Documents of the digital type can have various contents, such as music, text, images, video, or even a source code.

It may be desirable to compare digital documents, in particular in respect of their content.

In the case where two digital documents are stored in the form of two separate computer files, multiple comparisons can be carried out more or less directly.

The majority of the graphical user interfaces of current operating systems indicate, for example, the amount of memory necessary to store a particular file. The graphical user interfaces also display the date on which the file was last modified, the date on which it was created and/or the date on which the file was last accessed, as stored in the file itself.

Such a comparison is rough and not very reliable: two documents with different content may have been created on the same date and have the same size.

More reliable comparisons can be made by comparing two computer files octet by octet. There are many commercial computer tools which offer this possibility. However, this involves comparing computer files with one another and not comparing their contents: such tools in most cases simply establish whether the compared computer files are identical or not.

For example, when the files of two documents produced by different word processors, or by two different versions of the same word processor, are compared, such tools indicate in virtually all cases that the files are different. However, the text contained in the files may be identical, including the formatting thereof.

Some software allows the content of documents to be compared. This is true, for example, of most current word processors.

However, the possibilities for comparison offered by such software are not satisfactory.

Comparison is generally limited to the case where the corresponding files have been generated by the software in question.

It is then essentially manual, so that it quickly becomes tedious when multiple documents are to be compared with one another.

It is also limited to two computer files and becomes ineffective when a content, that is to say some text, is physically distributed over a number of separate computer files.

Furthermore, the comparison is carried out over the whole of the content, with the result that processing is relatively long in the case of documents of a large size and/or multiple comparisons of documents in pairs.

In addition, the result of such a comparison is limited to displaying the differences, or similarities, in the content without giving any other information relating to that content.

Finally, such software does not permit a confidential comparison of the documents: two authors wishing to compare their respective texts would be obliged to show them to one another or, at the very least, to allow a third party to see them.

In other words, the comparison of text files, as offered by commercial word processors, requires the content of the documents to be disclosed. And that may be unacceptable, for example when the documents in question relate to a literary work or part of a computer program.

Furthermore, there are devices capable of carrying out comparisons confidentially. For example, a deposit with the IDDN allows an author to obtain a unique coded key generated from one or more files corresponding to a content. If required, the key can be compared with another key. The operation of comparing the documents is then limited to the comparison of short character chains.

Such devices are not satisfactory either.

First of all, they simply conclude that two documents are identical or different, regardless of the extent or nature of that difference. Typically, simply replacing the column separator characters in a text file, from tabs to commas for example, is sufficient to generate different character chains.

Secondly, it is not possible with devices of this type to deal with only part of the content of a document, or more generally to deal with a document other than in its entirety. For example, in the case where a document included all or part of the content of another document, processing by devices of this type would be limited to concluding that there is a difference between the two compared documents. However, it may be desirable to identify such an incorporation of content, in particular when part of the ownership of a document is to be claimed.

Finally, the comparison of character chains requires the chains to have been generated by means of the same algorithm, or at the very least by means of analogous algorithms, in the sense that the algorithms must generate common or compatible signatures. Otherwise, it is not possible to conclude that there is a difference in content from a difference in keys.

However, over time, the coding algorithm may have been modified, on several occasions.

More generally, when any form of ownership is to be claimed over all or part of a document, it is necessary to compare the documents, in particular as regards their content, and obtain dating elements for the compared contents.

For example, if it is desired to claim part of the creation of a piece of software, it is necessary to possess the corresponding content of the source code, the key generated from that content and a date element proving especially that the content was not generated a posteriori, from the compiled software.

There are many persons, both natural persons and legal entities, acting as certification authorities. Such persons implement processes which consist, in a generic manner, in generating an archive from one or more documents, creating a unique key from the content of that document, and allocating to that key a timestamp element, in most cases in the form of a token, related to the date and time at which said process was carried out.

In that case too, the manner in which an archive is generated from one or more documents, the algorithm used to generate the key from said archive, and the process used to establish a token and the certification of that token may be caused to change over time.

In some cases, this makes it particularly tricky to claim any ownership when it is necessary to return to policies which may sometimes date from several years previously.

It is proposed to improve the situation.

The invention relates to a computer device for the time-based management of digital documents, of the type comprising a memory capable of storing at least one digital document and a respective date stamp, said date stamp defining a correspondence between one or more first signature values and at least one time value, the first signature values being established from the digital document according to a first signature method, a signature generator capable, when presented with a document content, of establishing one or more respective second signature values in accordance with a second signature method, a time stamper, including a time election function, capable of establishing a correspondence between one or more signature values and a value-result of the time election function, a signature verifier capable, when presented with a digital document content and a date stamp, of verifying their mutual conformity according to one or more predetermined rules, a supervisor capable, when presented with the digital document and its date stamp, of carrying out a particular processing operation. The particular processing operation consists in effecting the operation of the signature generator on the digital document in order to obtain one or more second signature values, in effecting the operation of the signature verifier on the digital document and the date stamp and, where the digital document and the date stamp match, in effecting the operation of the time stamper with at least the time value of the digital document and at least some of the second signature values in order to form a new date stamp including second signature values.

The device according to the invention allows document stamps, composed of signatures, to be compared, instead of comparing the documents themselves. This results firstly in a comparison that is rapid and inexpensive in terms of time and computing resources. Incidentally, the comparison is not limited to a comparison of documents in pairs. It follows that the comparison is more refined, in that a plurality of signatures can be generated from the same document.

The device according to the invention also allows documents to be compared whose stamps have been generated according to different signature methods. This can be effected while retaining the benefit of the date allocated to a stamp established according to a previous signature method, with a high confidence level.

The device according to the invention allows the contents of documents to be compared in terms of identity or difference. However, the device above all allows a time factor to be introduced into the comparison. In other words, it becomes possible to date the common elements or the elements by which documents differ from one another. In particular, the integration of parts of the contents of one document into another can be highlighted. In that case, it is also possible to identify an original document and a destination document by comparing the dates associated with the stamps.

Other features and advantages of the invention will become apparent on studying the detailed description hereinbelow and the accompanying drawings, in which:

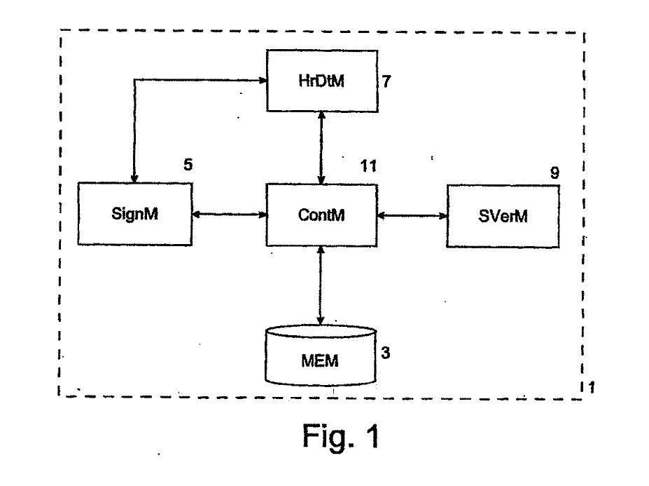

FIG. 1 is a block diagram of a device according to the invention.

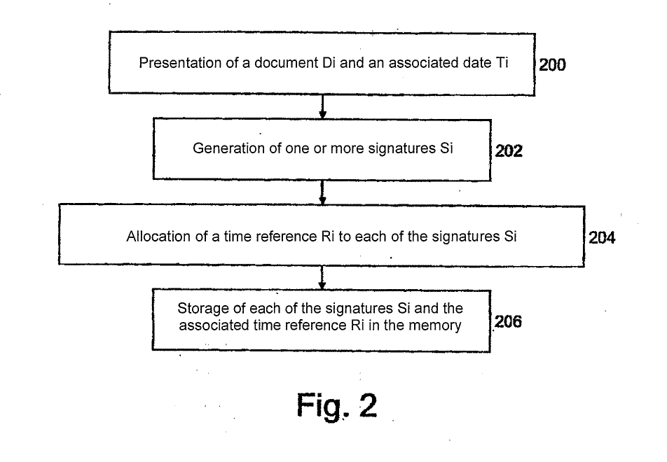

FIG. 2 is a flowchart showing the operation of a controller for the device of FIG. 1.

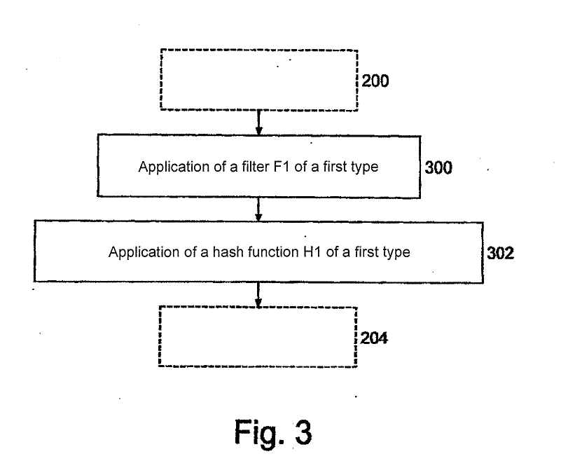

FIG. 3 is a flowchart showing the operation of a signature generator for the device of FIG. 1, in a first embodiment.

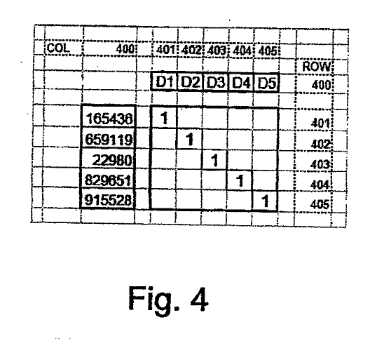

FIG. 4 is a table showing a time stamp generated by means of the signature generator shown in FIG. 3.

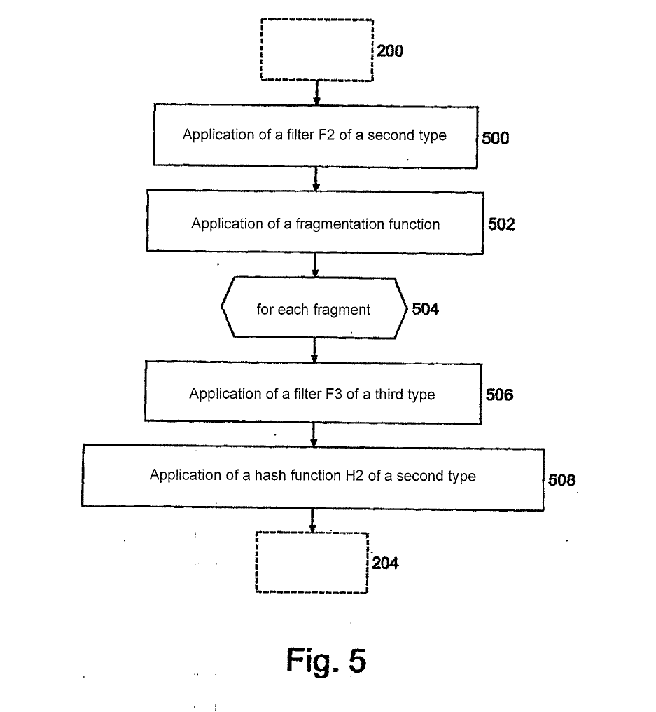

FIG. 5 is a flowchart showing the operation of the signature generator for the device of FIG. 1, in a third embodiment.

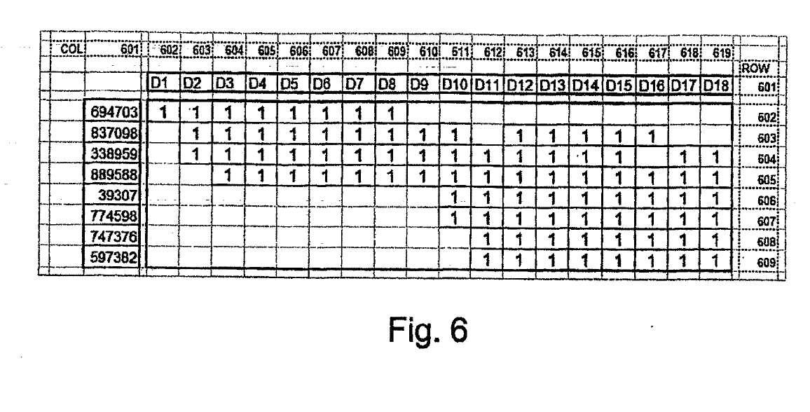

FIG. 6 is a table showing a time stamp generated by means of the signature generator shown in FIG. 5.

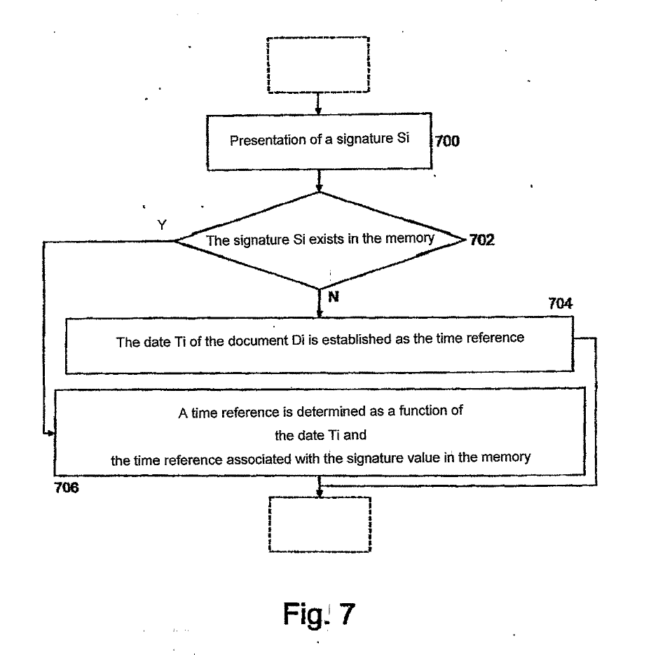

FIG. 7 is a flowchart showing an operating variant of the controller of FIG. 1, the signature generator being in accordance with its third embodiment.

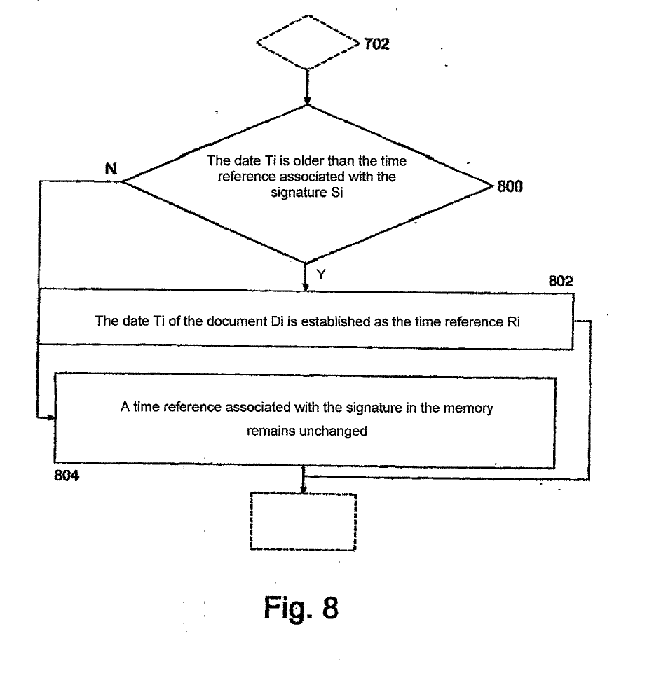

FIG. 8 is a flowchart showing the operation of a time stamper for the device of FIG. 1.

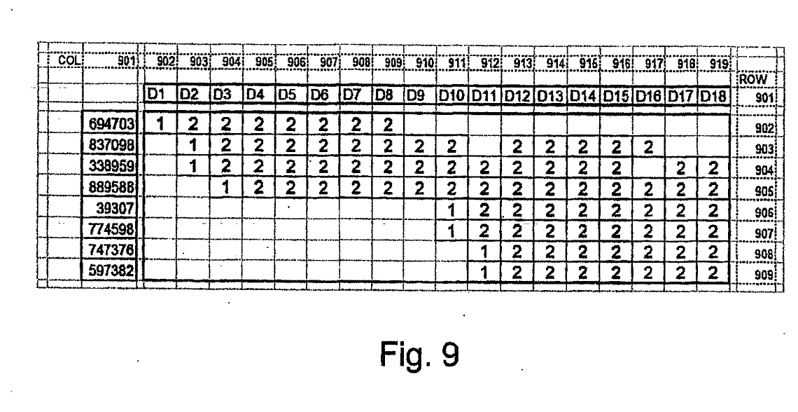

FIG. 9 is analogous to FIG. 6, in the operating variant of FIG. 7.

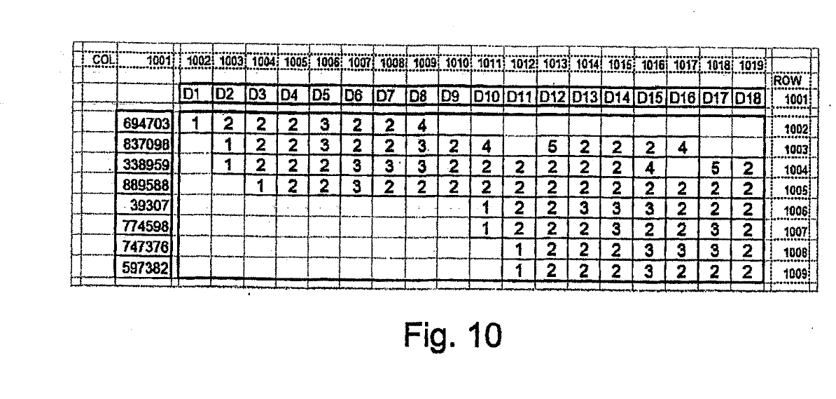

FIG. 10 is analogous to FIG. 6, in another operating variant of the controller of FIG. 1.

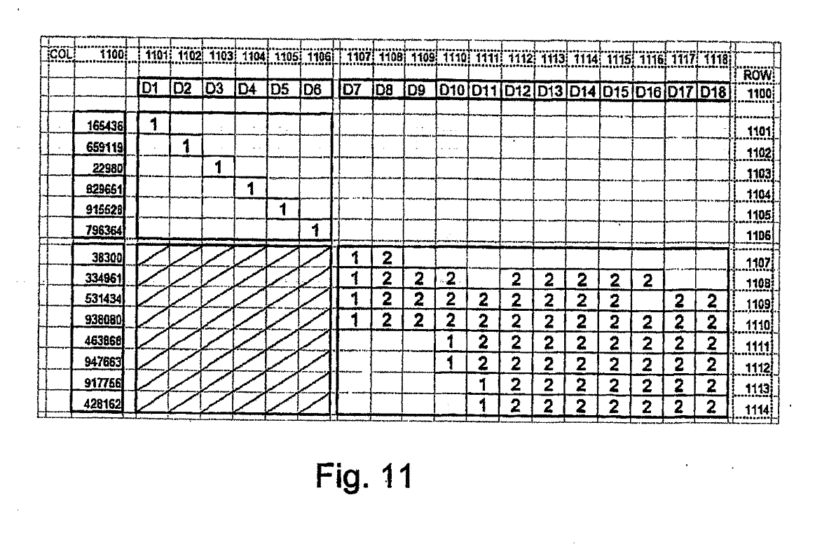

FIG. 11 is a table showing time stamps generated by means of the signature generator according to the first and third embodiments.

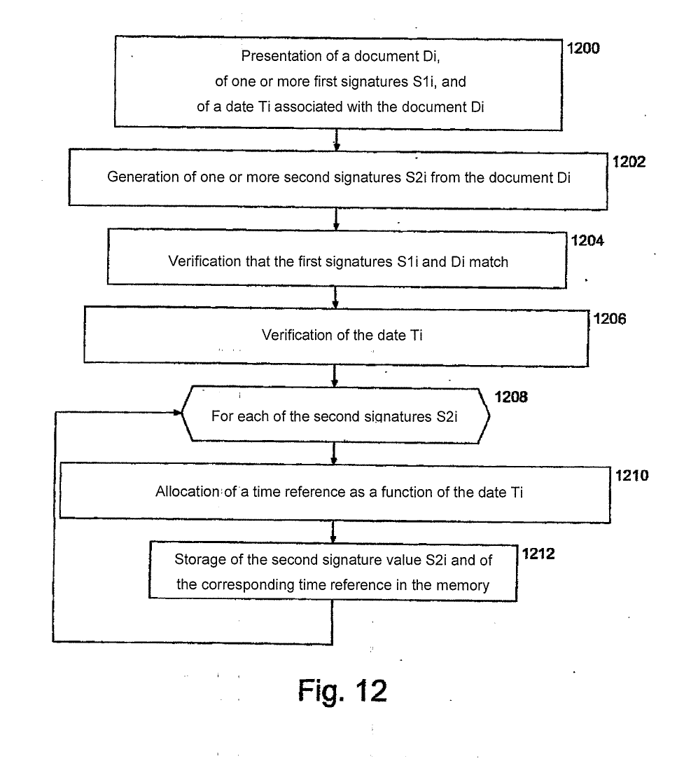

FIG. 12 is a flowchart showing a detail of the operation of the controller of FIG. 1.

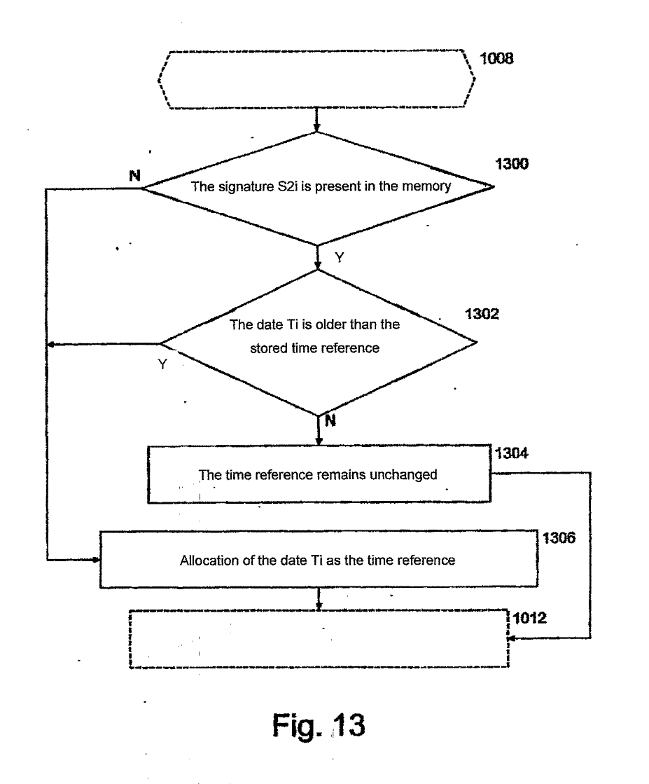

FIG. 13 is a flowchart showing another detail of the operation of the controller of FIG. 1.

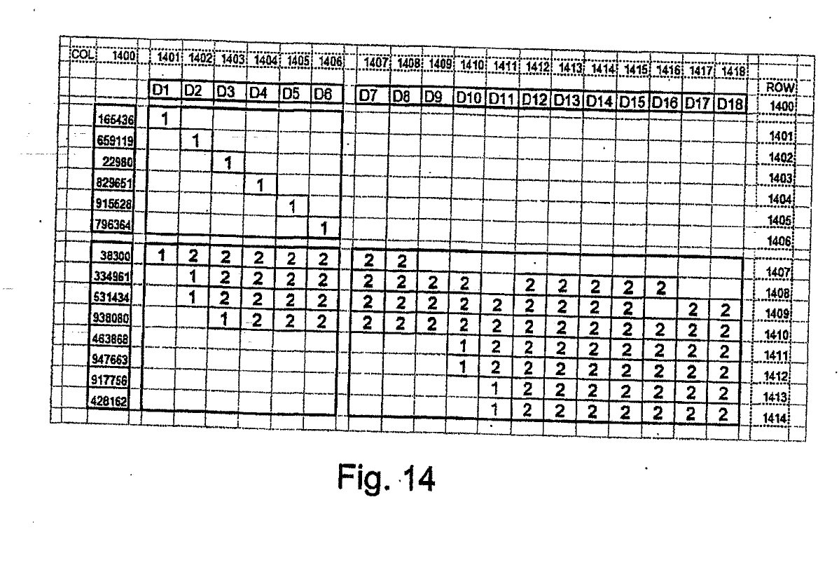

FIG. 14 is a table showing a time stamp, generated by means of the controller of FIG. 1 operating according to FIG. 13.

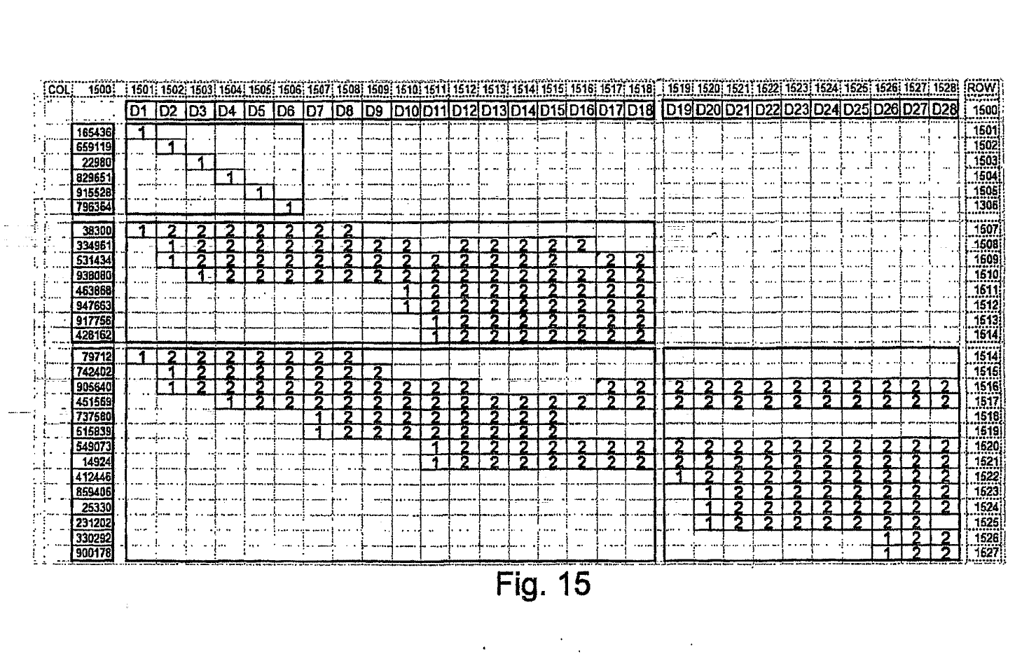

FIG. 15 is analogous to FIG. 14 for a variant.

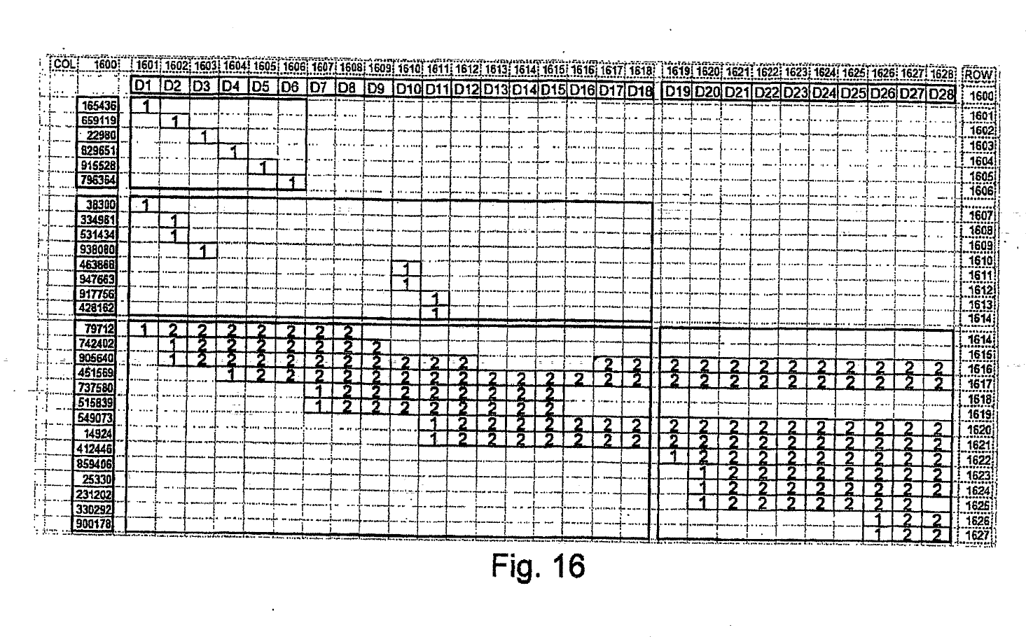

FIG. 16 is analogous to FIG. 14 for yet another variant.

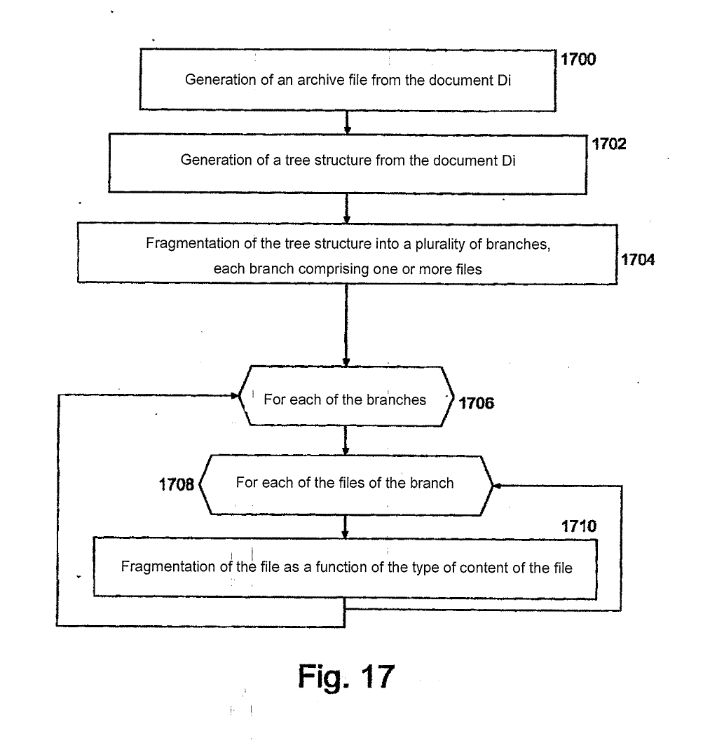

FIG. 17 is a flowchart showing the operation of a signature generator for the device of FIG. 1 according to another embodiment.

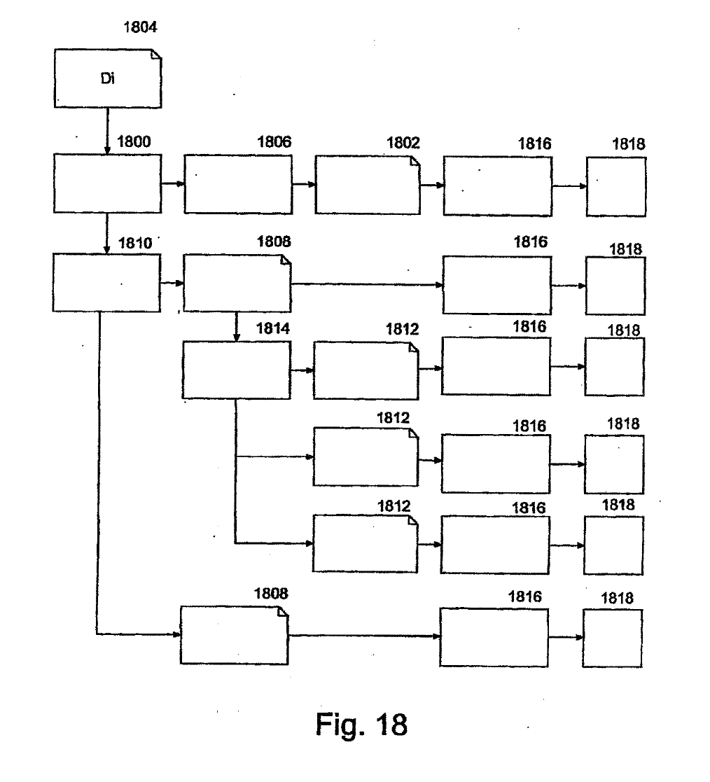

FIG. 18 is a diagram also showing the operation of the signature generator in the embodiment of FIG. 17.

The accompanying drawings may not only serve to complete the invention but may optionally also contribute to the definition thereof.

FIG. 1 shows a computer device 1 according to the invention for the time-based management of digital documents.

A digital document is here understood as being any coherent collection of content in digital form.

A digital document can correspond to one or more computer files of any type. An audio file, a video file and, more generally, all multimedia files, in raw format or compressed according to a standard, are examples of digital documents for which the computer device 1 can be used.

Files of the text type, either in a format particular to the software with which they were generated or in one of the standard text file formats, constitute other examples of digital documents.

Among such files of the text type, the invention is of particular interest in the case of files known as “sources”, that is to say comprising a series of instructions in any programming language which are to be compiled into instructions executable by a computing machine, typically a computer.

However, the invention is not limited to that particular application.

More generally, the computer device 1 is advantageously used on any digital document whose content is likely to have any form of creation, for example as governed by legal provisions relating to royalties.

In particular, the computer device 1 is found to be wholly effective when all or part of the ownership of a document is to be claimed, which involves establishing at one time or another a form of dependence between two documents, which especially requires the computer device to be robust against the evolutions which may occur over time.

Yet more generally, the computer device 1 can advantageously be used whenever it is of interest to obtain reliable information, in particular dates, relating to the content of a digital document.

In the remainder of the present description it should be noted that, whenever reference is made to a digital document, that document may physically be composed of a plurality of computer files. Exceptionally, some particular embodiments of the invention may require an individual digital document to correspond to a single computer file. That will then clearly be indicated.

For example, reference will regularly be made to a digital document in the case of a set of computer files of the “source code” type, constituting a version of a piece of software or, more generally, a step in a project under development. In that case, two separate documents may be seen as two separate versions of the project.

The term “content” of the document is not necessarily unrelated to the computer file or files which contain it or, more generally, its or their container applications. The content of the document can accordingly include its storage structure in digital form, or one or more attributes of its container application. The content of a computer file may include the name allocated to the computer file, in particular where the name of the file is strongly linked to the remainder of the content of the document, for example when the name of the file is the result of a naming convention which takes into account, for example, the date on which said file was generated. The content of the document may also include a complex hierarchical structure. For example, a file can include an archive, which includes directories and a hierarchical storage structure, the whole forming, for example, a computer software development project. The content of the archived file includes not only all of the source codes, but also the whole hierarchical storage structure of the sources.

The present convention may appear to go against conventional computer language, in which the meaning of the word “document” results mainly from the use of the word in the graphical user interface of some operating systems.

However, the meaning of the word “document” in popular speech is very much broader and corresponds wholly to the present convention. Moreover, it appears quite clearly that the cutting of a digital document into one or more computer files is in most cases an arbitrary choice to which the device according to the invention is virtually insensitive.

In some cases, a digital document may correspond to only part of a computer file.

The computer device 1 comprises a memory 3 capable, among other things, of storing digital documents, a signature generator 5 capable, when presented with a digital document, of establishing one or more signatures representing the content of that document, a time stamper 7 capable of assigning a time reference to each signature with which it is presented according to given timestamping rules, and a signature verifier 9 capable of verifying that a document content matches one or more signatures relating thereto.

The memory 3 can be organized in the manner of a database, for example of the relational type. It can be used with all types of file systems, such as FAT, NTFS, and with all operating systems, including Unix.

The computer device 1 further comprises a controller 11, or supervisor, capable of interacting with the signature generator 5, the time stamper 7, the signature verifier 9 and the memory 3.

FIG. 2 shows the operation of the controller 11.

A digital document Di and an associated date datum Ti are presented to the controller 11 in a step 200. The date Ti associated with the document Di is preferably a date relating to the creation of the document. In practice, the date Ti can be obtained in various ways. When the document Di corresponds to a project, the date Ti can come from a source storage server, from a source management tool such as CVS (for “Concurrent Version System”) or, more simply, it can correspond to a date on which the most recent/the oldest computer file was created. In the case of a single file, the date Ti can be the date on which it was created, as stored inside the file itself, a date certified by a third party, or a date on which the content was created, in particular when that date precedes the date of the computer file.

In a step 202, the controller 11 presents the document Di to the signature generator 5, which returns one or more signatures Si representing the content of the document Di.

Advantageously, the signature is statistically unique but coherent with the content of the document Di. This is understood as meaning that the probability of two separate contents giving rise to the generation of two signatures that are identical in value is as small as possible, while ensuring that two identical contents give rise to the same signature value.

For each of the signatures generated in step 202, the controller 11 calls the time stamper 7, which assigns at least one time reference Ri to a signature value, in a step 204.

Time reference is here understood as meaning a datum which relates to a date information, which may be relative or absolute, regarding the signature value in question, and more precisely the content which permitted the generation of that signature. A time reference Ri can be, without implying any limitation, in the form of a date or a correspondence to a date.

For example, a time reference Ri can be in the form of a version identifier in an organized series of documents. In some cases, a time reference Ri can refer to another time reference, optionally with additional information, such as “older” or “more recent”.

The controller 11 then interacts with the memory 3 and stores therein, for the document Di, all the signatures Si generated and their time references, in mutual correspondence.

That correspondence between a document Di, all the signatures Si generated from its content and the time references Ri associated with said signatures Si is here denoted “time stamp of document Di”.

FIG. 3 shows a first embodiment of the signature generator 5.

In this embodiment, a single signature Si is generated from a document Di.

The signature generator 3 is arranged to apply a filter function F1 of a first type to the document Di in a step 300.

The filter function F1 is principally arranged so that the signature Si generated for the document Di is robust against any minor change.

This is understood as meaning that the signature generated from the content of the filtered document Di must be identical with a signature generated from a document whose content is considered to be substantially identical with that of document Di.

The notion of “minor change” or “identity of contents” depends to a large extent on the type of document processed and on adopted conventions.

In the case of a file of the source type, it may be agreed that formatting of the content of the document constitutes only a minor change. The filter function F1 can then be arranged accordingly and, for example, apply a predetermined format to the content before the signature is generated. In a variant, the filter function F1 can be arranged to suppress any formatting.

The filter function F1 can likewise be arranged to suppress all comments of the file of the source type and/or characters foreign to the semantics of the programming language and/or characters dependent on a particular operating system, where it is agreed that the insertion of such elements does not significantly modify the content of the document Di.

The filter function F1 can also be arranged to rename, in accordance with a pre-established convention, all the variables and functions described in the file of the source type, so that the generation of signatures will become robust against an operation of renaming of those elements.

Other examples of modifications which may be deemed insignificant are:
modifications relating solely to the formatting of the content of the document, such as the addition of space characters or blank lines in a file of the text type,
the simple rewriting of the content, such as changing the names of variables or functions, and/or the addition or deletion of mentions of “copyright”, and/or
the modification of the name of one or more files storing the content, and more generally all modifications in the storage structure of the document, such as subdivision into one or more files, names of storage directories of the files, branching of the directories and the like.

The filter function F1 can optionally be adapted to the type of document Di and/or operating system on which the document Di was generated. Different filter functions F1 can be provided when a signature representing the content of a music, video or image document is to be generated.

The application of the filter function F1 is advantageous in that it improves the robustness of the signatures that are generated. The application remains optional.

The signature generator 5 is further arranged to apply a hash function H1 of a first type to the content of the document Di, optionally after application of the filter function F1. The hash function H1 returns a statistically unique signature Si representing the content of the document Di. In practice, such a signature can take the form of an alphanumerical character chain, other forms being possible.

The hash function H1 can be implemented in various ways.

For example, the hash function H1 can employ the encryption algorithms MD5, SHA-1 or SHA-256 and the like.

More generally, any function capable of establishing, from a document content, an identifier relating to that content can be used as the hash function H1.

Advantageously, preference will be given to hash functions H1 such that the signature generated is unique, or more precisely statistically unique. This subsequently enables signatures associated with documents to be compared, rather than the content of the documents. This results in a considerable gain in terms of computing time.

In practice, so-called “irreversible” or “inviolable” functions will advantageously be used, such as functions established on the basis of encryption algorithms.

The possible hash functions H1 are not limited solely to functions of the cryptographic type. Functions capable of giving other information pertinent to the content of a document, such as its closeness in terms of content to other documents according to pre-established conventions, can be used. Such functions do not disclose the content of the document but only a certain “closeness” to another document.

Such functions not only enable a statistically unique digital identifier to be obtained; they also prevent the content of the document Di, or an equivalent signifying that content, from being discovered from its signature, at least as far as reasonable effort allows.

The use of such functions permits a broad distribution of the signatures generated, with a minimal risk of disclosure of the contents. The latter may in fact contain a certain know-how, in particular when programming files are concerned.

In some cases it may, however, be preferred to disclose only part of the signatures generated, only some of them, for example the signatures generated from contents of a size exceeding a given threshold, and/or only some of the attributes associated with a signature.

A so-called “disclosure policy” may thus be put in place. This may be the case in particular when a set of documents constitutes successive versions of a piece of software that is in development. In that case, the successive disclosure of the signatures generated from each of those versions tends to provide additional information, so that the hash algorithms and the filter functions thereby necessarily become, in terms of probability, less reliable. This is particularly true in cases where, as will be seen hereinbelow, not one but a plurality of signatures is generated from the same document, because, in so doing, the information linking the signatures together is multiplied. The smaller the size of the content from which a signature has been generated, the less robust the filter and hash functions used against direct attacks, that is to say attacks aimed at discovering the content in question from the signature by successive attempts. Any indication of a link between the contents also impairs that robustness because it limits the necessary attempts.

According to a first variant of the first embodiment, the time stamper 7 is arranged so as to allocate to the signature Si its generation date as the time reference Ri. The generation date can be obtained from the operating system, optionally corroborated by a time server, and can be in the form of a timestamp token.

According to a second variant of this first embodiment, the time stamper 7 is arranged to allocate to the signature Si the date Ti associated with the document Di as the time reference Ri. This allocation can be conditional upon obtaining evidence that substantiates the date Ti, for example a declaration by a certification authority, or a timestamp token.

According to a third variant of this first embodiment, the time stamper 7 is arranged to allocate to the signature Si the date Ti associated with the document Di if, and only if, the date Ti is associated with an acceptable confidence level, and otherwise to allocate the signature generation date.

Whatever the variant, the time stamper 7 can be arranged to further call a time election function for the signature value Si.

The time election function can be arranged to verify the existence of the signature Si in the memory 3 and, where that signature exists, to allocate as the time reference Ri one of the new time reference Ri and the time reference already stored. For example, the oldest of those two time references can be allocated to the signature Si. This especially allows a date of first appearance of the signature Si in a set of documents to be displayed. The date of first appearance can serve as a basis for the identification of the integration of content of one document into another.

FIG. 4 shows the time stamps of documents D1 to D5 obtained by means of the signature generator 5 in its first embodiment.

The various signatures are indicated in column COL400 and the identifiers of the various documents in row ROW400. Correspondence between a signature and a particular document is indicated by the presence of a framed numeral

For example, the time stamp of document D1 includes the signature “165436” (presence of the numeral “1” in box COL401,ROW401).

Here, the time references Ri associated with the signatures Si were determined by means of the date Ti associated with each of the documents Di. In other words, the value of the time reference Ri is not indicated explicitly here in the figure, but correspondence between a signature Si and the time reference Ri is deduced from the presence of a numeral “1”.

This can also be seen as the allocation of a document number as the time reference Ri, the documents Di having been numbered chronologically, for example here on the basis of the dates Ti associated with them.

This shows that the time reference Ri is not necessarily in the form of a date. In some cases, as here, the time reference can be relative.

The signature “165436” has the date associated with document D1, the oldest of the documents Di, while the signature “915528” has the date of document D5, the most recent of the documents Di.

The memory 3 is arranged to store for each document Di, here documents D1 to D5, the signature Si generated and the time reference Ri associated with that signature value. The memory 3 can optionally be organized to store a correspondence between several documents, here, for example, a link is stored between the stamps of documents D1 to D5.

In a second embodiment of the signature generator 5, the generation of time stamps from document Di is carried out outside the computer device 1.

The signature generator 5 is arranged to recover at least an identifier of a document Di, a signature Si generated from the document Di, and a date associated with that signature Si.

A plurality of documents can be received simultaneously. The memory 3 can then be arranged to store the time stamps of a set of documents Di linked together.

As an option, the time-stamper module 7 can call a time election function for each of the signatures Si in order to establish a new time reference Ri from time references associated with the signature Si in the memory 3.

In a first variant of this second embodiment, the date associated with the signature Si is considered to be a priori valid. This corresponds to a relatively low confidence level in the correctness of the date associated with the signature Si. This nevertheless has the advantage that the device is relatively simple to operate.

In a second variant, the signature generator 5 is arranged to verify the validity of the date associated with the signature value Si. For example, the signature generator 5 can be arranged to receive a timestamp token from a third time stamper providing reliable storage forms.

In that case, a timestamp token can be associated in a unique manner with the signature Si, a date being allocated to the token. When the validity of the token is verified, a confidence level in the association of the signature and the date similar to the confidence level granted to the emitter of said token is obtained. Multiple verification procedures exist, which procedures depend substantially on the emitter of the token. For example, the token, and optionally a date and/or the signature Si, can be presented to an intermediary service for certification of the association of the date and the signature. In other cases, the emitter of the token can make known a public key particular thereto, which key can be used to verify the consistency of the token with the signature Si and a date value. The token is not necessarily directly accessible to the device 1. In some cases, only a reference to a timstamp token, stored with a third party, may be accessible.

Procedures of a different type can also be implemented in order to verify the validity of the date associated with the signature Si.

FIG. 5 shows a third embodiment of the signature generator 5.

In this embodiment, a plurality of signatures Si are generated from a document Di. This allows a more refined comparison of documents Di with one another to be carried out.

The signature generator 5 is arranged to apply a filter F2 of a second type to any document Di presented to it, in a step 500.

In a step 502, the signature generator 5 applies to the content of the document Di so filtered a fragmentation function, which is capable of extracting the content of the document Di and dividing it into a plurality of elements according to predetermined rules.

The fragmentation function, and the rules according to which that function is implemented, can be arranged in different ways.

For example, in the case of a file of the source type, the content of which is written according to a particular programming language, the fragmentation function can be arranged to extract each of the described functions from the document Di. The fragmentation rules can then be established on the basis of a search for expressions dedicated to the declaration of function-type objects in the programming language in question.

In the case where a document is physically organized into a plurality of computer files, including files which have complex relationships between them, the fragmentation function can be arranged to individualize those computer files, at least in the first instance.

Given that the notion of “content of a document” is more general than merely the information that it is possible to display on a computer, such as the text contained in a text file, the image of an image file or a film contained in a video file, the fragmentation function can be arranged to act on non-displayable elements. For example, the fragmentation function can be arranged to extract the structure, or branching, of an archive, such as an archive in TAR.GZ format for example, and more generally on the storage structure of the content of a digital document. The fragmentation function can further be arranged to act on elements of different sizes or “granularities”. For example, in the case where a document Di represents a set of source files, the fragmentation function can be arranged first to cut the documents into files, thus representing a first level of granularity, and then to cut said file into functions. In other words, the result of the fragmentation function applied to the document Di is a set of files and a set of functions contained in those files. In other words, there will be generated for a computer file a signature corresponding to that file and a signature for each of the functions contained in the file.

The fragmentation function can thus be arranged to cut a document Di several times and in different ways, in a non-successive manner, each of the cutting operations providing a set of elements to be signed.

In a step 504, the signature generator 5 begins a loop on each of the parts of the content of the document Di obtained in step 502.

The loop begins by the application of a filter function F3 of a third type, in a step 506, and continues with the application of a hash function H2 of a second type in a step 508.

The filter function F2 aims above all to render the result of the fragmentation function as robust as possible. In other words, the filter function F2 is arranged so that two documents composed in a similar manner are cut in the same manner. Consequently, the filter function F2 can be established in relation with the fragmentation function.

In the case of files of the source type, the filter function F2 can be arranged to format the content of the document, in accordance with a presentation convention, while the fragmentation function is arranged to cut as a function of the presentation in question.

The filter function F3 substantially meets requirements analogous to those of the filter function F1, in particular as regards the robustness of the signatures generated.

The filter function F3 can be adapted as a function of the type of content of the cut part: different filters can be used depending on whether the cut parts correspond to functions, data, image parts or musical items.

Reference is made here to a single hash function F2 for the purpose of simplicity. In practice, a plurality of different hash functions may be implemented, which functions can, for example, be adapted according to the content of the part to be processed.

According to a first variant of this third embodiment, the time stamper 7 is arranged to allocate the date Ti associated with the document Di as the time reference Ri to each of the signatures Si generated for that document Di, at least in the first instance.

This can be effected by means of a time election function, which establishes the date Ti as the time reference. In some cases, the date Ti can be accompanied by a confidence index datum. The time election function can then be arranged to establish the date Ti as the time reference Ri only if the confidence index exceeds a certain predetermined threshold. Otherwise, the date on which the processing is carried out can be used as the time reference Ri.

FIG. 6 shows the time stamps of documents D1 to D18 established by means of the signature generator 5 in the first variant of the third embodiment.

For example, the stamp of document D4, represented by column COL605, is constituted by the signature values “694703”, “837098”, “338959” and “889588”, as indicated by the presence of the framed numbered element “1” in that column.

In this embodiment, each of the signatures of D4 has for the time reference the date T4 corresponding to document D4.

More generally, each of the signatures Si generated from a particular document Di receives in this embodiment the date Ti associated with the document Di as the time reference Ri.

FIG. 7 shows a second variant of this third embodiment.

The time stamper 7 here calls a time election function to assign a time reference Ri to each of the signature values Si from signatures stored in the memory 3.

The time stamper 7 is arranged to receive a signature value Si, relating to the content of a document Di, in a step 700.

In a step 702, the time stamper 7 cooperates with the memory 3 to determine whether the signature Si is already stored in the memory. In a variant, the search for the signature Si can be limited to documents Dj whose stamps are stored in relation with the document Di in question.

If yes, then the time stamper 7 is arranged to call a time election function with all the dates associated with said signature in the memory 3 and the date Ti associated with the document Di, in a step 706. The time election function returns a time reference Ri, calculated from those dates, which will be stored in correspondence with the signature in question.

Otherwise, the date Ti associated with the document Di is established as the time reference Ri of that signature, in a step 706.

Here, the time election function works on the set of time stamps already stored in the memory 3 to allocate to the signatures Si calculated from a new document Di time references Ri potentially calculated from the dates Ti of documents Di already processed.

This allows a global stamp to be established for a set of documents, in which a set of signatures is included, each signature having an associated time reference.

This also allows the time references Ri associated with the signatures Si to be updated gradually as documents Di are processed by the computer device 1. It becomes possible to create a library of time stamps which can be used for the comparison of a plurality of documents, including future documents, without storing the documents themselves.

FIG. 8 shows an example of the time election function.

In a step 800, the time election function verifies if the date Ti is older than the time reference Ri associated with the signature Si in the memory 3.

If yes, then the time reference Ri assumes the value of the date Ti associated with the document Di, in a step 802.

Otherwise, the time reference Ri remains unchanged (step 804).

In this embodiment, the time reference Ri is determined as the oldest date of presence of the signature Si in the set of documents Di processed.

The time election function can optionally be arranged to take into account other criteria, such as an index of reliability of the date Ti, for example.

FIG. 9 shows the time stamps of documents D1 to D18 established according to the second variant of the third embodiment.

Column COL901 groups together the signatures generated from documents D1 to D18. The documents D1 to D18 are ordered chronologically in row ROW901 by virtue of, for example, their associated date Ti.

The presence of a framed numeral at the intersection of a column corresponding to a document Di and a row corresponding to a signature indicates that the content of said document has resulted in the generation of that signature.

For example, document D3 has resulted in the generation of the signatures “694703”, “837098”, “338959” and “889588”.

The presence of the numeral “1” opposite a signature (COL901) indicates the time reference Ri associated with that signature: this time reference Ri is equivalent to the date Ti of the document Di opposite which the numeral is positioned.

For example, the signature “889588” has as its associated time reference the date T3 of document D3. In this embodiment, this means that this signature appeared for the first time in document D3 among the set of documents D1 to D18.

The presence of the numeral “2” opposite a signature Si indicates the presence of that signature Si also among the signatures generated for document Di opposite the numeral “2”.

For example, the signature “889588” was generated for documents D4, D5 or also D6, D7 and D8, etc.

Here, the memory 3 stores a relationship not only between each signature value Si and its time reference Ri, but also between that signature value Si and the date Ti of each of the documents Di for which that signature value Si has been generated. In other words, each signature Si has an associated time reference Ri and one or more dates of presence.

In the case of files of the source type, the documents Di of FIG. 9 can be seen as each representing a version of a project in the course of development. In that case, the time reference Ri corresponds substantially to a date of appearance of a source code element in the project in question.

This can permit, inter alfa, the identification of a contribution to the development of the project. In the case where one or more natural persons or legal entities can be linked to the document Di whose associated date is the time reference for a particular signature value Si, it is possible to quantify the contribution made by that person or entity to the development, in particular relative to persons linked with documents Di that do not constitute the time reference of any signature value of the global stamp.

Of course, this is merely a quantification element, which can be supplemented by other information, in particular with a view to aiding the allocation of the capacity of author to some contributors and not to others.

According to a third variant of the second embodiment, the signature generator 5 and the time stamper 7 are arranged to cooperate with one or more devices capable of establishing information relating to differences and/or similarities between documents.

For example, such a device can be in the form of a version management tool, for example of the CVS type. For example, a version management tool working on the file scale is capable of determining whether a file belonging to a set of files constituting a piece of software in the process of development has or has not been modified since the preceding version.

When the same signature value is found in two documents, therefore two different versions of the same project, it is possible to distinguish whether the signature value is associated with a file that has not been modified between those two versions of the project, or whether the presence of that signature is associated with a file that has been modified, potentially insufficiently in terms of the filters used to generate a different signature.

FIG. 10 shows the time stamps of documents D1 to D18 established with the aid of the signature generator 5 and the time stamper 7 in the third variant of the second embodiment.

A numeral “3” indicates that the signature comes from a modified file.

For document D5, the presence of the numeral “2” opposite the signature “338959” indicates that the file from which this signature has been generated has not been modified since version D4. The presence of the numeral “3” opposite the signature “694703”, on the other hand, indicates a modification of the file from which that signature has been generated between versions D4 and D5.

The signatures can be generated according to different granularity levels. For example, a signature Si can be generated for a file, and additional signatures Si for each of the elements of the content of that file. When a file has undergone a modification, the signature Si linked with the file can be new and associated with a value 2. The signatures Si corresponding to content elements of that file can be identical (presence of 3 opposite the signatures corresponding to the content).

Such an analysis is authorized by interaction with version management tools, because the latter are capable of indicating divergent elements between two versions.

Given that the memory 3 stores the dates of presence of the signatures Si, it is possible to calculate dates of last appearance or disappearance, indicated by the presence of the numeral “4” in a square frame.

For example, the signature “837098” is absent from document D11 and appears for the last time in document D10. It reappears in document D12. In this variant, it has been chosen to indicate the reappearance of a signature Si in the set of documents Di in a different manner (presence of a numeral “5”). This is the case, for example, for the signature “837098” in document D12.

Documents D1 and D18 form part of a set of documents, for example the different versions of the same project, or of the same document.

The time stamps enable dependencies between documents to be determined. Dependency is here understood as being the inclusion of part of the content of one document in another, including the case of modifications cancelled out by the different filters applied.

This time-based management of documents, with the aim especially of establishing their mutual dependence, is sensitive to the filter functions that are applied and to the hash functions that are used.

Insofar as different signatures, in terms of value and potentially of number, will be generated for the same document Di owing to the use of different filter, fragmentation and hash functions, it appears a fortiori difficult to compare document stamps generated according to different filter, hash and fragmentation functions.

However, these functions are by their nature caused to evolve:
in order to maintain a suitable level of irreversibility thereof (hash functions can be “cracked”)
in order regularly to improve the robustness thereof, and/or
by the absence of the existence of a standard, which has the result that stamps generated by a third party may be different from stamps generated in-house.

In FIG. 11, columns COL1101 to COL1106 relate to documents D1 to D6 subject to dates on which the signature function operated with filter F1 and the hash function H1. These stamps may also correspond to deposits made with intermediary time stampers.

Columns COL1107 to COL1118 relate to a time stamp generated with the aid of filters F2 and F3 and hash function H2 for documents D7 to D18.

In the crossed part (COL1101 to COL1106, ROW1107 to ROW1109), it is not possible to compare documents D1 to D6 with documents D7 to D18: each of the signatures generated for documents D1 to D6 differs from the signatures generated for documents D7 to D18 without it being possible to attribute such a difference in signatures to differences in content rather than the use of different hash and filter functions.

More particularly, it is not possible to allocate to the signatures generated for documents D7 to D18 a time reference Ri that precedes the date T7 associated with document D7 owing to the differences in processing between documents D1 to D6 and D7 to D18. However, the content that led to the generation of the set of signatures for documents D7 to D18 may have been present in documents D1 to D6.

This disadvantage is further illustrated by the presence of the numeral 1 opposite each of the signatures generated from document D7.

The controller 11 is here arranged in an advantageous manner which allows this disadvantage to be overcome.

FIG. 12 shows the way in which the controller 11 is arranged.

In a step 1200, the controller 9 receives:
a document Di,
a stamp of the document Di constituted by one or more signatures S1i, or first signatures, established with the aid of a first filter and a first hash function, and
a date Ti associated with the document Di.

The stamp of the document Di can come from the signature generator 5 of the device 1 arranged with the first hash H1 and filter F1 functions.

The stamp of the document Di can also come from an external device, such as a source file storage server, for example.

In a step 1202, the controller 11 calls the signature generator 5 for the establishment of one or more signatures S2i, or second signatures, from the document Di. These second signatures S2i are established according to one or more second filter and hash functions, for example the functions F2, F3 and H2 described above.

In a step 1204, the controller 11 presents the set of first signatures S1i to the signature verifier 9 in order to verify that the first signatures S1i match document Di.

The signature verifier 9 can be arranged so that it verifies said match itself. For example, the signature verifier 9 can carry out the first filter F1 and hash H1 functions on the document Di. To that end, the signature verifier 9 can call the signature generator 5 arranged with the first filter F1 and hash H1 functions.

In general, verification that the first signatures S1i match the document Di by the signature verifier 9 involves the disclosure of the filter and hash functions used, for example simultaneously with the signatures. In the case where those functions are subject to standards or norms, reference to the latter is nevertheless sufficient.

The signature verifier 9 can also be arranged so that said match is verified by an additional device, for example a third party. Disclosure of the filter and hash functions, which can constitute elements of know-how, is thus avoided.

If the first signatures S1i are judged not to match document Di, then the processing can be interrupted.

In a step 1206, the signature verifier 9 verifies that the date Ti associated with the document Di is pertinent. If the date Ti is judged to be not pertinent, then the processing can be interrupted or, by way of variation, can be continued while replacing the date Ti with the current date of the system.

In a step 1208, the controller 11 presents each of the second signatures S2i to the time-stamp module 7.

In the case where the date Ti has been judged to be pertinent, the time-stamp module 7 calls the time election function with that date Ti in order to allocate a time reference Ri according to one or more pre-established rules (step 1210).

In the case where the date Ti is not pertinent, or if the document Di from which the second signatures S2i were generated does not match the first signature S1i, the time election function cannot be called with the date Ti.

The time election function can nevertheless be called with the current date of the system or the date on which the document Di was recorded in the memory 3. And that date can be established as the time reference Ri. As an option, the second signature S2i can be the subject of a time-stamping operation.

In a step 1212, the controller 11 commands the recording of a correspondence between each of the second signatures S2i and the time reference Ri which has been allocated thereto in the memory 3. As a variant, the controller 11 also commands the recording of a correspondence between each of the second signatures S2i and the date Ti.

FIG. 13 shows the allocation of a time reference Ri to a second signature S2i according to a particular embodiment of the controller 11.

In a step 1300, the controller 11 verifies whether the signature S2i is present in the memory 3.

If yes, then the time election function is called with the date Ti and the time reference Ri associated with the second signature S2i in question in the memory 3.

Here, the time election function establishes as the new time reference Ri the oldest of the current time reference Ri and the date Ti.

In other words, it is determined whether the date Ti is older than the time reference Ri associated with the signature value S2i in question in the memory 3 (step 1302).

If yes, then the date Ti is established as the time reference Ri (step 1306). Otherwise, the time reference Ri remains unchanged (step 1304).

In the case where the signature S2i in question is absent from the memory 3, then the date Ti associated with the document Di is established as the time reference (step 1306).

In the variant where a correspondence between a second signature value S2i and the date Ti of the document Di is stored in step 1012, whatever the time reference Ri associated with that second signature value S2i, the time election function can be called with the date Ti of the document Di currently being processed and the set of dates Ti associated in the memory with that signature S2i in order to update the attributes associated with that signature, which depend on the time reference Ri or the dates Ti.

That is the case especially when the device 1 is coupled to a tool for managing the different versions of a document, as explained above in the description of FIG. 10.

According to a first variant, verification that the first signatures S1i match the document Di is effected by regeneration of the signatures. Starting from the document Di, a set of signatures is generated with the aid of the first filter and hash functions. If the set of signatures regenerated is identical with the set of first signatures S1i, then the first signatures S1i are judged to match the document Di.

Here, the two sets are considered to be identical if each of the signatures of one set is found in the other, and vice versa.

If the two sets are identical, then the date Ti is judged to be pertinent.

In the case where the date Ti is judged to be pertinent, the time stamper 7 can establish the date Ti as the time reference Ri for each of the second signatures S2i.

According to a second variant, the stamp received in step 1200 comprises a single signature S1i for the document Di. A timestamp token Ji for the signature S1i is also received.

Verification that the first signature S1i matches the document Di can be effected by signature regeneration.

In the case where the first signature S1i matches the document Di, the controller 11 verifies the validity of the timestamp token for the first signature S1i. The verification of validity includes verifying that the token Ji corresponds to the first signature S1i. The verification can also include verification of the validity of the token Ji itself, for example with the emitter of the token. These two verifications can be carried out concomitantly by virtue of a public key/private key process attributed to the emitter of the token.

If the token Ji is judged to be valid for the signature S1i, then the controller 11 verifies that the date of the token Ji corresponds to the date Ti.

If the date of the token Ji corresponds to the date Ti, then the date is judged to be pertinent. In that case, the confidence level which can be accorded to the date Ti is similar to the confidence level accorded to the emitter of the token Ji.

In some cases, a small time difference between the date of the token Ji and the date Ti may be tolerated without calling the pertinence of the date Ti into question again. In practice, technical constraints do not allow the token Ji to be generated exactly on the date Ti.

According to a third variant, the stamp received in step 1200 comprises a plurality of first signatures S1i. A plurality of timestamp tokens Ji are also received.

The controller 11 verifies that the first signatures S1i match the document Di, for example by signature regeneration.

If the first signatures S1i match the document Di, then the controller 11 verifies the validity of the tokens Ji for the first signatures:
for each of the timestamp tokens Ji there must exist at least one first signature S1i validly associated with that token, and
there must be validly associated with each of the first signatures S1i at least one valid token Ji.

If the tokens Ji are valid for the first signatures S1i, then the controller 11 verifies that the date of each of the tokens Ji corresponds to the date Ti.

If all the dates of the tokens Ji correspond to the date Ti, then that date Ti is judged to be pertinent.

As an option, the date Ti can be judged to be pertinent despite a difference between some dates of the tokens Ji and the date Ti. In that case, a high confidence level may be accorded to a date Ti which corresponds to the set of dates of the tokens Ji, while a low confidence level will be attributed when at least some of the dates of the tokens differ from the date Ti. Intermediate confidence levels may be attributed as a function of the number of tokens Ji whose dates differ from the date Ti.

Whatever the variant of the controller 11, it can be arranged so as to successively process a set of documents Di.

FIG. 14 shows the result of the processing by the controller 11, according to the third variant of the controller 11, in combination with the time reference allocation process of FIG. 13.

The signature generator 5 has, for example, operated on document D1 in order to allocate thereto as the only second signature S21 the value “38300”. The second signatures “38300”, “334961” and “531434” were generated for document D2, and “38300”, “334961”, “531434” and “938080” were generated for document D3.

The dates T1, T2 and T3 associated, respectively, with the first signatures of those documents D1, D2 and D3 (see COL1401;ROW1401, COL1402;ROW1402 and COL1403;ROW1403) were judged to be pertinent. The date T1 associated with the first signature “165436” of D1 can accordingly be allocated to the second signature S21 of D1, and the date T2 associated with the first signature of D2 can be allocated to the second signatures S22 of D2. For example, the second signature “38300” of D2 has as the time reference the date T1 associated with D1 because that date T1 precedes the date T2 associated with D2.

In column COL1407, the time references R7 of the second signatures associated with document D7 visible in FIG. 13 have been revised in the light of the processing carried out on documents D1 to D6. The values “1” indicating the date T7 as the time reference Ri for the second signatures S27 have been replaced in FIG. 14 by values “2” indicating the date T7 as the date of presence solely for those signatures.

According to a fourth variant, the stamp received in step 1200 includes a plurality of first signatures S1i and, for each of those first signatures S1i, one or more dates Tj associated with documents Dj whose stamp includes that first signature S1i, the dates Tj preceding the date Ti. A timestamp token Ji is also received for the oldest of the dates Tj of each of the first signatures S1i. Finally, a set of documents Dj, including at least each of the documents Dj whose date Tj is present in the stamp of the document Di, is accessible to the controller 11. The documents Dj may be present in the memory 3 because they have already been processed or transmitted prior to or simultaneously with step 1200.

The controller 11 verifies that the set of first signatures S1i match the document Di, for example by regeneration of the first signatures S1i.

For each of the first signatures S1i, the controller 11 verifies that the associated dates Tj are coherent with the prior documents Dj. For each of the dates Tj, the controller 11 verifies, starting from the documents Dj, that the signature S1i in question is effectively present in each of the documents Dj whose date Tj is present in the stamp, and only in those. The controller 11 further verifies that the date Tj indicated as being the oldest is effectively the oldest in view of the stored prior documents Dj. That verification can include a step of regeneration of the stamps of the documents Dj.

If the dates Tj are coherent with the prior documents Dj, then the controller 11 verifies the validity of the timestamp tokens Ji. For each of the tokens Ji, the controller 11 verifies that there exists at least one first signature S1i with which the token Ji is validly associated. The controller 11 then verifies that each of the first signatures S1i is validly associated with a token Ji. The controller 11 thus establishes a set of valid tokens Ji.

For each of the first signatures S1i whose oldest date Tj corresponds to the date Ti, the controller 11 verifies that the date of the token or tokens Ji validly associated with that signature S1i corresponds to the date Ti.

For the other first signatures S1i, the controller 11 verifies that the date of the associated token or tokens precedes the date Ti.

The date Ti is judged to be pertinent if all the verifications are positive.

The controller 11 can be arranged to process a set of documents Di in chronological order of their date Ti. In that case, the documents Di processed previously are advantageously stored in the memory in order to enable the document Di to be processed without having to re-transmit the prior documents Di. Chronological processing further has the advantage that the time references Ri associated with the documents already processed are no longer likely to change. This results in savings in terms of processing.

FIG. 15 shows the result of the processing of the controller 11 according to the fourth variant of the controller 11, in combination with the time reference allocation process of FIG. 13.

The set of documents D1 to D18 are processed by the controller 11. In FIG. 15, the stamp of a document Di as supplied in this embodiment includes all the columns corresponding to the prior documents (D1 to Di−1) and the column of document Di, for rows ROW1507 to ROW1514. The result of the processing is visible in the region of columns COL1501 to COL1518 and rows ROW1507 to ROW1514.

According to a fifth variant, the stamp received in step 1200 includes only first signatures S1i newly associated with the document Di. For each of those first signatures, there are also received one or more timestamp tokens Ji for that first signature S1i. Finally, a set of documents Dj whose date Tj precedes the date Ti is accessible to the controller 11.

The controller 11 verifies that the set of first signatures S1i match the document Di, for example by regeneration of the first signatures S1i. This verification of a match is here limited to verifying that the first signatures transmitted are in fact present in the stamp regenerated for document Di.

For each of the first signatures S1i, the controller 11 verifies that the first signature S1i is actually newly associated with the document Di. In other words, the controller 11 verifies that none of the stamps corresponding to the prior documents Dj includes that first signature S1i. This is equivalent to verifying the coherence of the date Ti associated with the signature S1i in relation to the set of prior documents Dj stored in the memory.

If the date Ti of each of the first signatures Si1 is coherent with the prior documents Dj, then the controller 11 verifies the validity of the timestamp tokens Ji in a manner identical to that of the fourth variant.

For each of the first signatures S1i, the controller 11 verifies that the date of the token or tokens Ji validly associated with that signature S1i corresponds to the date Ti.

If all the dates associated with the tokens Ji are identical to Ti, the date Ti is judged to be pertinent.

As for the fourth variant, the controller 11 can here be arranged to process a set of documents Di in chronological order of their date Ti, in a repeated manner.

FIG. 16 shows the result of the processing of the controller 11, according to the fifth variant of the controller 11, in combination with the time reference allocation process of FIG. 13.

The set of documents D1 to D18 are processed by the controller 11. In FIG. 16, the stamp of a document Di as supplied in this embodiment includes all the columns corresponding to the prior documents (D1 to Di−1) and the column of document Di, for rows ROW1607 to ROW1614. The result of the processing is visible in the region of columns COL1601 to COL1618 and rows ROW1607 to ROW1614.

In a variant of the device 1, the first filter and hash functions are compatible with the second filter and hash functions. This is understood as meaning that, when those functions are applied to the same document Di, the set of second signatures S2i includes at least some of the first signatures S1i.

FIG. 17 shows an example of the arrangement of the signature generator 5 in this variant. And FIG. 18 shows the result of the processing of this signature generator. These figures are described together.

In a step 1700, the fragmentation function 1800 of the signature generator 5 produces a computer file 1802 of the archive type from a document Di 1804, which document Di can include a plurality of computer files. Various archive file formats can be used here, for example “zip” files, “tar” files, “image iso” files or others. The archive file thus constitutes a first fragment generated from the document Di. The generation of the archive file can use an archive generator 1806.

In a step 1702, the fragmentation function generates a tree structure of the document Di. Different criteria can be used to produce this tree structure. For example, the tree structure can be generated according to the computer storage structure of document Di: each branch can correspond to a directory used to store computer files. The tree structure can also differ from that storage structure, it then being possible for files to be created and distributed between different branches as follows: the part of a software project under development to which they correspond, the version of the software under development in which they appeared, etc.

In a step 1706, the fragmentation function generates a plurality of branches, each branch containing one or more files. Each of the branches corresponds to a fragment 1808. This can be accomplished by means of a tree generator 1810.

The fragmentation function begins a loop on each of the branches (step 1706) and on each of the files of the branch in question (step 1708).

Starting from a file, or a branch, the fragmentation function generates a plurality of fragments 1812 according to the type of file in question (step 1710). The fragmentation function can be capable of cutting a file of the source type, in a particular language, into significant elements of that language, each of those elements forming a fragment of the document Di. For example, the fragmentation function is capable of identifying, for that language, functions, blocks, data and/or also data structures. In the case where the file type is unknown to the fragmentation function, for example if the file corresponds to a programming language which the fragmentation function does not know how to process, the file is left as it is. The part of the fragmentation function used for this operation is shown by block 1814.

The signature generator applies a first hash function 1816 to each of the fragments generated by the fragmentation function. The stamp generated for the document Di accordingly includes signatures Si to each of which there can be allocated a hierarchical level as a function of the type of element from which said signature has been generated.

For example, the signature S1L1 1818 generated from the archive file 1802 has an attribute of level 1, while each of the signatures S1L2 1820 generated from a branch 1808 has an attribute of level 2 and each of the signatures S1L3 1822 generated from a significant element 1812 has an attribute of level 3.

One probable evolution of the fragmentation function consists in modifying it so as to process ever more files of different types. For example, the fragmentation function can be modified so that in future it is capable of cutting an image file. The fragmentation function can further be modified so as to cut source files in previously unknown languages.

In other words, a new fragmentation function is created each time such an evolution occurs, each new fragmentation function leading to a new configuration of the signature generator 5 compatible with the preceding ones, in the sense explained hereinbefore.

In this variant, the controller 11 can be arranged to take into account the hierarchical attributes associated with the signatures in order advantageously to control the transition between two compatible arrangements of the signature generator 5.

Accordingly, according to a sixth variant of the controller 11, the stamp received in step 1200 includes only a first signature S1i of highest hierarchical level. A timestamp token Ji for that first signature of highest level is also received.

The controller 11 compares the first signature S1i of highest level with the second signature S2i of highest level. Here, it is not necessary to generate first signatures again from the document Di because the filter and hash functions used are compatible.

If the first signature S1i of highest level corresponds to the second signature S2i of the same level, then the first signatures are judged to match document Di.

Verification of the pertinence of the date Ti here consists in verifying the timestamp token Ji in respect of its association with the first signature S1i of highest level and in respect of its date, which must be identical with date Ti.

According to a seventh variant, the controller 11 is advantageously arranged for the case where the signature generator 5 used for the first signatures S1i differs from the signature generator 5 used for the second signatures S21 only in the method used to generate the signatures of highest level.

The stamp received in step 1200 includes a plurality of first signatures S1i and, for each of those signatures having a lower hierarchical level than the highest level, a timestamp token Ji.

Verification that the first signatures match the document Di does not require the first signatures to be generated again. The controller verifies that the set of first signatures S1i of low level are found in the second signatures S2i. If that is the case, the first signatures are judged to match the document Di.

Verification of the pertinence of the date Ti here consists in verifying the validity of the tokens Ji in respect of their association with the first signatures and in respect of their date, which must correspond to the date Ti.

According to an eighth variant, the signature generator 5 used for the first signatures S1i differs from the signature generator 5 used for the second signatures S2i by the inclusion of additional filter and hash functions. In other words, for the same document Di, the set of first signatures is contained in the set of second signatures. Consequently, verification that the signatures S1i match the document Di can be limited here to verification of the inclusion of the set of first signatures S1i in the second signatures S2i.

This is advantageous when the signature generator 5 is arranged to regularly integrate standardized filter and hash functions, as the standards develop.

The invention is not limited to the embodiments described solely by way of example above, but includes all variants which may be envisaged by the person skilled in the art.

In particular:
The invention can also be described in the form of a process for the time-based management of digital documents, of the type comprising the following steps:
   storing at least one digital document and a respective date stamp, said date stamp defining a correspondence between one or more first signature values and at least one time value, the first signature values being established from the digital document according to a first signature method,
   establishing one or more respective second signature values from the digital document according to a second signature method,
   verifying that the date stamp matches the digital document according to one or more predetermined rules,
   in the case where the digital document matches the date stamp, establishing a correspondence between at least some of the second signature values and a value-result of a time election function called with at least the time value of the digital document in order to form a new date stamp including second signature values.
Optionally, the process comprises one or more of the following steps:
   associate a time reference in the date stamp with each signature value, as the value-result of the time election function.
   call, for at least some of the signature values, the time election function with the time value of the stamp of said digital document and time values of stamps of additional digital documents including said signature value.
   establish said time reference at least on the basis of a criterion of anteriority of the time values with which the time election function has been called.
   generate a set of third signatures according to a third signature method, compare the set of third signatures with the set of first signatures of the date stamp, and decide on said match on the basis of the result of this comparison.
   decide on said match where the set of third signatures and the set of first signature values are identical.
   fragment the digital document and generate a first signature from each of said fragments, associate a fragmentation level with each of the first signature values as a function of the fragment on which the generation of that first signature is based.
   verify the presence in the set of third values of first signature values associated with a given fragmentation level, and decide on said match on the basis of the result of this verification.
   said third signature method including a plurality of signature methods, verify that the set of first signatures is included in the set of third signatures, and decide on said match on the basis of the result of this verification.
   compare the time value of the date stamp with a date value associated with one or more certification elements associated with one or more first signature values, and decide on said match on the basis of the result of this comparison.
   verify the identity of the time value of the date stamp and a date value associated with one or more certification elements associated with one or more first signature values, and decide on said match on the basis of the result of this verification.
   associate a plurality of time values with each of the first signature values in the date stamp, each of those time values corresponding to a stamp of an additional digital document including that first signature value, verify that those time values match additional digital documents, decide on the match between the date stamp and the digital document on the basis of the result of this verification.
   establish an indication of the oldest time value among a plurality of time values associated with each of the first signature values in the stamp.
   cooperate with an external certification device in order to verify that the date stamp matches the digital document.
   apply said process to a plurality of documents in a repeated manner, call the time election function each time with at least some of the value-results obtained during the preceding application.
The invention permits the creation of time-stamp libraries which are to be used in the comparison of documents, including future documents. The small amount of memory taken up to store a stamp, in comparison with the storage of one or more documents, makes it possible to compare a large number of documents and, in particular, makes such a comparison very quick.
The invention further renders the storage of the stamps compatible with the evolutions which are likely to occur in the methods used to generate signatures. This allows a library capable of working over long periods of time to be produced.
The different embodiments of each of the elements of the device according to the invention can be combined, in particular as regards the signature generator 5.

1. Computer device for the time-based management of digital documents, of the type comprising:
a memory capable of storing at least one digital document and a respective date stamp, said date stamp defining a correspondence between one or more first signatures and at least one time value, the first signatures being established from the digital document according to a first signature method,
a signature generator capable, when presented with a document content, of establishing one or more respective second signatures according to a second signature method,
a time stamper, including a time election function, capable of establishing a correspondence between one or more signatures and a value-result of the time election function,
a signature verifier capable, when presented with a digital document content and a date stamp, of verifying that they match according to one or more predetermined rules,
a supervisor capable, when presented with the digital document and its date stamp, of carrying out the following operations:
effecting operation of the signature generator on the digital document in order to obtain one or more second signatures,
effecting operation of the signature verifier on the digital document and the date stamp, and
in the case where the digital document matches the date stamp, effecting operation of the time stamper with at least the time value of the digital document and at least some of the second signatures in order to form a new date stamp including second signatures.

2. Device according to claim 1, wherein the time stamper is arranged to associate with each signature a respective time reference in the date stamp, as the value-result of the time election function.

3. Device according to claim 1, wherein the time stamper is capable of calling, for at least some of the signatures, the time election function with the time value of the stamp of said digital document and time values of stamps of additional digital documents including said signature.

4. Device according to claim 3, wherein the time election function is arranged to establish said time reference at least on the basis of a criterion of anteriority of the time values with which the time election function has been called.

5. Device according to claim 1, wherein the signature verifier is capable of generating a set of third signatures according to a third signature method, and wherein at least one of said predetermined rules relates to the result of a comparison of the set of third signatures with the set of first signatures of the time stamp.

6. Device according to claim 5, wherein said third signature method includes a plurality of signature methods.

7. Device according to claim 5, wherein one of said predetermined rules relates to the fact that the set of first signatures are included in the set of third signatures.

8. Device according to claim 5, wherein the signature generator is arranged to generate the set of third signatures from said digital document.

9. Device according to claim 5, wherein at least one of said predetermined rules relates to the identity of the set of third signatures and the set of first signatures.

10. Device according to claim 1, wherein the first signature method includes fragmentation of the digital document and the generation of a first signature from each of said fragments, and wherein each of the first signatures is associated with a level of fragmentation of the fragment on which the generation of that first signature is based.

11. Device according to claim 10, wherein the signature verifier is capable of generating a set of third signatures according to a third signature method, and wherein at least one of said predetermined rules relates to the result of a comparison of the set of third signatures with the set of first signatures of the time stamp, and wherein one of said predetermined rules relates to the presence of first signatures associated with a given level of fragmentation in the set of third signatures.

12. Device according to claim 1, wherein one of said predetermined rules relates to a comparison of the time value of the date stamp with a date value associated with one or more certification elements associated with one or more first signatures.

13. Device according to claim 12, wherein one of said predetermined rules relates to the identity of the time value of the date stamp and a date value associated with one or more certification elements associated with one or more first signatures.

14. Device according to claim 1, wherein each of the first signatures is associated in the date stamp with a plurality of time values, each of those time values corresponding to a stamp of an additional digital document including that first signature, and wherein the signature verifier is arranged to verify that those time values match additional digital documents.

15. Device according to claim 1, wherein the stamp includes, for each of the first signatures, an indication of the oldest time value among a plurality of time values associated with that first signature.

16. Device according to claim 1, wherein the signature verifier is capable of cooperating with an external certification device in order to verify that the date stamp matches the digital document.

17. Device according to claim 1, wherein the supervisor is arranged to carry out said processing on a plurality of documents in a repeated manner, the time stamper being capable each time of calling the time election function with, in addition, at least some of the value-results obtained in the preceding processing.
